(19) United States
(12) Patent Application Publication
(10) Pub. No.: US 2007/0027978 A1
(43) Pub. Date: Feb. 1, 2007

(54) Information acquisition and distribution system

(76) Inventors: Jeffrey Charles Burkman, Houston, TX (US); Richard Lewis Seegmiller, Sugar Land, TX (US); Donald J. Sands, Rosenberg, TX (US); Royce Alan Engler, Panorama Village, TX (US)

Correspondence Address: CONLEY ROSE, P.C., P. O. BOX 3267, HOUSTON, TX, 77253-3267, US

(21) Appl. No.: 10/570,678

(22) PCT Filed: Sep. 29, 2004
(86) PCT No.: PCT/US04/31845

§ 371 Date: Mar. 3, 2006

(30) Foreign Application Priority Data
Sep. 29, 2003 (US) 60506898

(51) Int. Cl. G06F 15/173

(52) U.S. Cl. 709/224

(57) ABSTRACT

Methods and apparatus for a network adapted to acquire, analyze, and distribute information regarding time sensitive and area specific events. The system acquires information from a plurality of available sources and filters the data to detect reportable events as defined by a selected criteria. The detected reportable events are then analyzed and processed to generate messages describing the reportable events. These messages, along with corresponding data as to the time, place, urgency, and nature of the event, are then transmitted to users via a variety of transmission options. The messages may be received by conventional communications equipment, such as telephones, cellular phones, pagers, fax machines, etc. and/or by specialized equipment designed to operate with the preferred system.

### STATEMENT REGARDING FEDERALLY SPONSORED RESEARCH OR DEVELOPMENT

Not Applicable.

### BACKGROUTND OF THE INVENTION

1. Field of the Invention

The invention relates generally to methods and apparatus for acquiring, analyzing, and distributing information. More particularly, the invention relates to a system to acquire information from a plurality of sources, analyze that information, and distributing selected information to selected receivers.

2. Description of the Related Art

As the information age progresses, the demand for accurate, timely information is increasing dramatically. Further, the ever increasing amounts of information available make the task of parsing and filtering this information an increasingly daunting task. Even once valuable information is identified, the dissemination of that information is difficult given the number of new communication devices and methods now available.

One area in which these communication problems are especially evident is in notification of emergency situations. Fast, efficient communication of emergency situations is critical in communities susceptible to both natural and manmade disasters. For most residences of these communities, advance warning, or immediate notification, of these disasters is non-existent or relies on antiquated technology. Therefore, many of these early warnings and notifications reach only a small percentage of the population and are largely ineffective.

For example, one common emergency notification system uses an audible alarm broadcast in the form of a siren or air horn. These audible alarms are common in extreme weather warning systems and for alerting those in industrial areas to mishaps or chemical releases. These alarms may be difficult to hear indoors, especially if the transmitter is located at a distance from the listener. Also, simple audible alarms offer no information about the nature or severity of the event, but merely act as an alert that something has happened.

Another common emergency alert system is a telephone-based alert system. Once an alert has been generated, these telephone-based systems utilize a system of computers to automatically dial phone calls to a list of numbers within a certain zone. Although the telephone-based system allows the dissemination of more particularized information than simple audible alarm systems, there is still no guarantee that large numbers of people are actually receiving the message. Additionally, some telephone systems can not accommodate the volume of calls necessary to notify a densely populated area in a limited amount of time, therefore further hindering the notification process.

Of course, most people rely on television or radio broadcasts to receive information concerning emergency conditions. The emergency notifications that utilize these mediums are able to provide useful information but are generally broadcast over a larger area than would otherwise be necessary. Further, they require that the receiver be turned on, which often requires an active source of electrical power, and that the people to whom the notification is intended are paying attention. Like the other systems, there is no way of verifying that the intended audience received the warning.

Therefore, there remains a need in the art for an information acquisition and distribution system that is directed, efficient, flexible, and reliable. Thus, the embodiments of the present invention are directed toward methods and apparatus for acquiring, analyzing, and distributing information that seek to overcome certain of these and other limitations of the prior art.

### SUMMARY OF THE PREFERRED EMBODIMENTS

The preferred embodiments are directed toward a network adapted to acquire, analyze, and distribute information regarding time sensitive and area specific events. One preferred system acquires information from a plurality of available sources and filters the data to detect reportable events as defined by a selected criteria. The detected reportable events are then analyzed and processed to generate messages describing the reportable events. These messages, along with corresponding data as to the time, place, urgency, and nature of the event, are then transmitted to users via a variety of transmission options. The messages may be received by conventional communications equipment, such as telephones, cellular phones, pagers, fax machines, etc. and/or by specialized equipment designed to operate with the preferred system.

Among the specialized equipment that may be used in conjunction with the preferred systems are stand-alone dedicated receivers, telephone-based receivers, radio-based receivers, television-based receivers, and personal computer-based receivers. In the preferred embodiments, these specialized receivers have the capability of receiving the broadcast messages, using audio and/or visual alarms to signal a user that a message has been received, and displaying the message for the user. In the preferred embodiments, the equipment would send a message back to the system once a user acknowledges the receipt of the message.

Thus, the present invention comprises a combination of features and advantages that enable it to provide for the acquisition, analysis, and distribution of information. These and various other characteristics and advantages of the preferred embodiments will be readily apparent to those skilled in the art upon reading the following detailed description and by referring to the accompanying drawings.

### BRIEF DESCRIPTION OF THE DRAWINGS

For a more detailed description of the preferred embodiments of the present invention, reference will now be made to the accompanying drawings, wherein:

FIG. 1 is a general schematic representation of an information acquisition and distribution system;

FIG. 2 is a schematic representation of an information acquisition and distribution system;

FIG. 3 is a front elevation view of one embodiment of a radio-based receiver;

FIG. 4 is a schematic view of the receiver of FIG. 3;

FIG. 5 is a schematic view of a telephone-based receiver;

FIG. 6 is a schematic view of a radio-based public address system;

FIG. 7 is a schematic view of a radio-based broadcast system; and

FIG. 8 is a schematic view of a television based system.

### DESCRIPTION OF EXEMPLARY PREFERRED EMBODIMENTS

In the description that follows, like parts are marked throughout the specification and drawings with the same reference numerals, respectively. The drawing figures are not necessarily to scale. Certain features of the invention may be shown exaggerated in scale or in somewhat schematic form and some details of conventional elements may not be shown in the interest of clarity and conciseness. The present invention is susceptible to embodiments of different forms. There are shown in the drawings, and herein will be described in detail, specific embodiments of the present invention with the understanding that the present disclosure is to be considered an exemplification of the principles of the invention, and is not intended to limit the invention to that illustrated and described herein. It is to be fully recognized that the different teachings of the embodiments discussed below may be employed separately, or in any suitable combination, to produce the desired results.

In particular, various embodiments described herein thus comprise a combination of features and advantages that overcome some of the deficiencies or shortcomings of prior art information distribution networks. The various characteristics mentioned above, as well as other features and characteristics described in more detail below, will be readily apparent to those skilled in the art upon reading the following detailed description of preferred embodiments, and by referring to the accompanying drawings.

The preferred embodiments include a system adapted to gather, catalog, analyze, and distribute time sensitive and area specific events. Events may be defined as any news item, weather alert, emergency situation, or other information identified by as being of interest. Time sensitive events are those events for which an individual, or group, must be notified within minutes. The value of time sensitive event notification decreases rapidly with time. Area specific events are those events of particular interest to individuals within a certain geographic area. The value of area specific event notification decreases as the distance from the event location increases. A geographical area may be defined as an area bounded by a closed polygon, the location of which is described by a coordinate system such as the global positioning system (GPS). The area may be a pre-defined area, such as, but not limited to, a fixed device location, sub-division, zip-code, city, county, state or country.

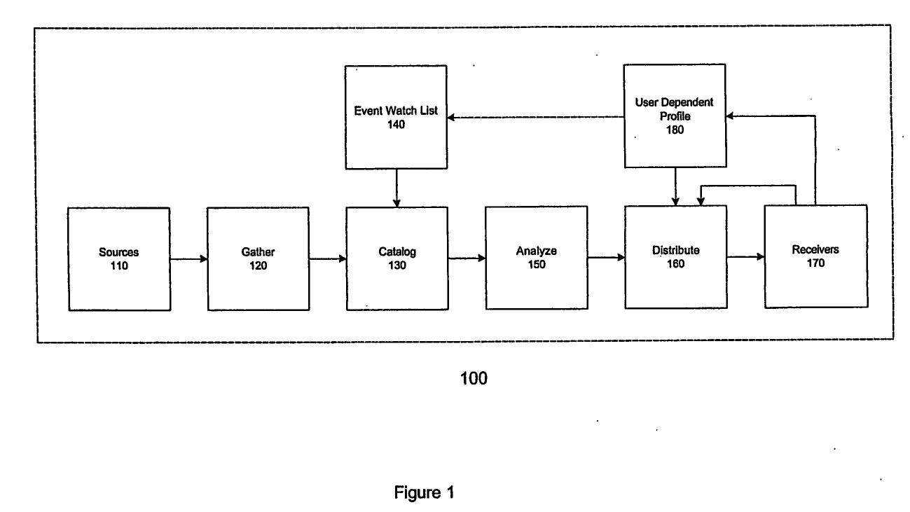

Referring now to FIG. 1, a simplified schematic representation of one embodiment of a preferred system 100 is shown. System 100 involves receiving input sources 110 in a data acquisition/gathering process 120. Gather process 120 feeds information to a catalog/event detection process 130, which uses an event watch list 140 to identify pertinent events and information. The identified events are transferred to a data and event analysis process 150, which generates an appropriate message to describe the identified events and determines a priority for the message. Distribution system 160 takes these generated messages, accompanying information and uses information from the user dependent profile 170 and distributes them to receivers 180, which may optionally be capable of sending an acknowledgement of the receipt of the message back to the distribution system 160. Receivers 180 may be capable of providing current geographical location information to user dependent profile 170.

In the general operation of system 100, information generated by input sources 110 is gathered by acquisition process 120. Depending on the source, this information may be raw data or pre-filtered information. The catalog process 130 takes the information and compares it to an event watch list 140, which is preferably generated based on a user dependent profile 170, preferences. Once the catalog process 130 identifies an event, the analysis process 150 takes the event information, including time, place, description, etc., and generates an appropriate message (including an urgency level). The message, along with accompanying data related to the event, is sent to distribution system 160 where it is distributed to selected receivers 180. Feedback from receivers 180 to distribution system 160 and user dependent profile 170 enable system 100 to track which receivers received the message as well track the physical location of selected receivers.

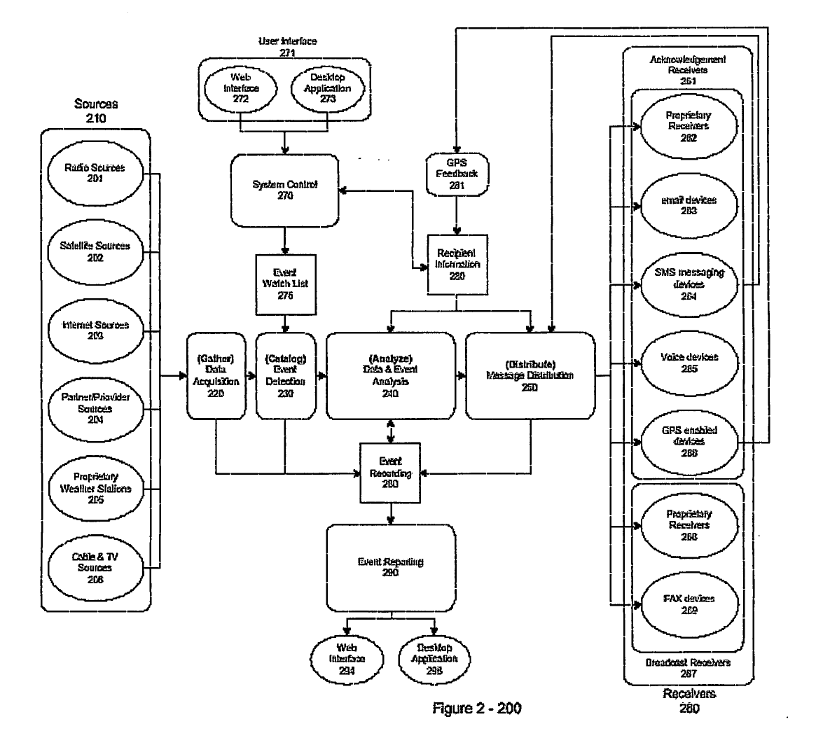

Referring now to FIG. 2, a schematic of one preferred process 200 is shows Process 200 acquires information from information sources 210, including, but not limited to, radio sources 201, satellite sources 202, internet sources 203, information partners/providers 204, weather services 205, and television broadcast sources 206. Process 200 includes gathering 220, cataloging 230, analyzing 240, and distributing 250 information to receivers 260.

Receivers 260 include acknowledgement receivers 261 that are capable of two-way communication, including, but not limited to, specialized receivers 262, email devices 263, text messaging devices 264, voice devices 265, and GPS enabled devices 266. Acknowledgement receivers 261 send a signal back to system 200 to indicate that a message has been received. GPS enabled devices 266 may also send a signal to system 200 indicating the current location of the receiver. Receivers 260 also include broadcast receivers 267 that support only one-way communication. Broadcast receivers 267 may be specialized receivers 268 or other equipment, such as fax machines 269, which do not send signals back to system 200.

Supporting cataloging function 230 is system control process 270, which draws information from sources 271. Sources 271 may include a web interface 272 and desktop application 273. Sources 271 are used to produce an event watch list 275 containing criteria against which gathered information will be compared in order to determine relevance. Event watch list 275 is preferably customized for a particular user or group of users.

Supporting analysis 240 and distribution 250 is a recipient database 280 that contains all information related to preferences and requirements for transmitting messages to recipients and recipient location. Database 280 is populated with data drawn from sources that may include web interfaces 272, desktop applications 273, and GPS feedback 281.

Maintained in the background of system 200 is event recorder 290. Event recorder 290 contains information provided by the gathering 220, cataloging 230, analyzing 240, and distribution 250 of information as it is processed by system 200. The information contained in event recorder 290 is used to provide a record of the information coming into system 200, the processing of that information to generate messages, and the distribution of those messages. Recorder 290 can be monitored by event reporter 292, which is accessed by web interface 294 or desktop applications 296.

Gather process 220 monitors sources 210 to acquire data relating to possible events and other information. Data from sources 210 collected in gather process 220 is cataloged in event recording system 290 to document the event occurrence, the actions taken as a result of the detection of the event, and if available, the results of those actions. Catalog process 230 receives data from gather process 220 and filters the data to determine what data may indicate a reportable event.

To filter the data, catalog process 230 uses event watch list 275 to identify events for which data is available. One example of this data would be National Weather Service (NWS) bulletins, which include metadata that identifies the geographic area and criticality of the NWS bulletin. Event watch list 275 is generated by system control process 270 that uses input from subscribers and operators by way of a web interface 272 or desktop applications 273.

System Control process 270 includes a subscriber information list that is populated as subscribers are added to the system. The attributes of the recipient information list 280 include a list of events for which the subscriber desires to be notified, and the geographical identifiers that define the subscriber's location, as well as other descriptors used for billing and other administrative functions. The CRUD (Create, Revise, Update and Delete) process for the subscriber information list includes the ability to update geographical location via GPS if the subscriber is using a mobile device that is capable of broadcasting its GPS coordinates.

The data stream from gather process 220 is automatically analyzed and monitored for events that match items in event watch list 275. Once an event is identified by catalog process 230, documentation is saved to recording system 290 so that the context of the data stream may be preserved. Catalog process 230 may also include event identification by an on-watch staff in an operations center even if the events are not automatically matched to items in the event watch list 275.

Once an event is identified, the details of the event are sent to the analyze process 240. The details of the event may include the trigger from the event watch list 275, an identifier of the event context captured in event recorder 290, a descriptor of the coordinates of the event, and an indicator of the urgency of the event.

After an event is cataloged, the context of the event is extracted from the recording system 290 by analysis process 240 where it can be displayed to the Operations Center staff for analysis and action. In the preferred embodiments, there are two interconnected attributes for each event that must be determined, namely the urgency of the event and the affected area.

First, if not already determined from the event watch list 275 trigger, the urgency of the event must be determined. One preferred urgency identification system uses a color coded methodology such as red for warning, yellow for watch, and green for information. Some events will be automatically assigned warn or watch level urgency. For example, a tornado will automatically be assigned a warn level of urgency.

Second, the geographical area affected must be determined. The result will be one or more defined geographical areas with associated urgency levels. For events of watch or warn urgency, a threat gradient may also be assigned to the identified geographical area(s) indicated a decreasing threat based on increasing distance from the event. Of those users for which the event triggered a message, the area most at risk will be classified as Warn/Red urgency, the area that may be at risk will be classified as Watch/Yellow urgency, and the area not at risk will be classified as Information/Green urgency. For Information events, there is generally no threat gradient.

In the analysis process 240, an appropriate message for each urgency level in the threat gradient and the corresponding geographical area is created. In order to minimize response times, certain events and types of events will have pre-defined messages, which may be available from the event watch list 275. Once appropriate messages are generated, the message and geographical distribution are approved, either automatically or by a Shift Supervisor, and transmitted electronically to the distribution process 250.

For each message to be sent, analyze process 240 identifies the recipients that are within the affected geographical areas from the subscriber information list by searching for matches between the subscriber's geographical identifiers and the defined threat geographical area in event recording 290. When a match is obtained, the process 240 captures the subscriber's associated receiving device identifiers and message delivery channels for delivery to the message distribution process 250.

For each level in the threat gradient for which a message has been associated, the message to be delivered and the list of the targeted recipients, as well as the associated receiving devices for which they are subscribed, is communicated to the message distribution process. Each recipient may subscribe for one or more devices to which the message may be delivered. These devices 260 are either simplex devices that are incapable of providing acknowledgement that the recipient (a human) has received the message, or duplex devices which are capable of providing acknowledgement that the recipient (a human) has received the message.

Each device has a specific message delivery channel associated with it that specifies the format and size of the message to be transmitted, and the method of transmission. Possible message delivery channels include, but are not limited to, Nortel Companion Access Toolkit (CAT), Adaptive LED Sign Protocol (EZ95), Free-Form Transfer Protocol (FTIP) (for wireless LANs and marquees), SpectraLink's Open Application Interface (OAM), Microsoft Windows Popup Protocol (WPP), Paging Entry Protocol (PET), Short Message Peer to Peer (SMPP), Simple Mail Transfer Protocol (SMTP), Simple Network Paging Protocol (SNPP), Telocator Alphanumeric Paging protocol (TAP), Telephony Application Programming Interface (TAPI), Telocator Network Paging Protocol (TNPP), Wireless Communication Transfer Protocol (WCTP), and Short Messaging Service Protocol (SMS).

Messages are sent to the devices associated with each recipient using the appropriate communication protocol and message delivery channel(s) associated with the device. Documentation of sent messages is captured in event recorder 290. When the recipient (a human) has received (acknowledged) the message, those devices 261 that are capable of providing message-received acknowledgment, communicate the acknowledgment back to message distribution 250 in the context of the acknowledgment protocol and message delivery channel that the device is capable of using. Devices 261 may use a different message delivery channel to communicate acknowledgement than the channel used to receive the message. As message-received acknowledgments are received, documentation of receipt to event recorder 290 is made.

Devices

System 200 is capable of transmitting messages and accompanying data to a variety of receivers 260 by a variety of different communication protocols. In the preferred embodiments, system 200 interacts with specially designed receivers that are designed to take advantage of the information provided by the system. These devices may communicate using a variety of different mediums, such as radio, television, cellular signals, pagers, and other wireless or wired systems.

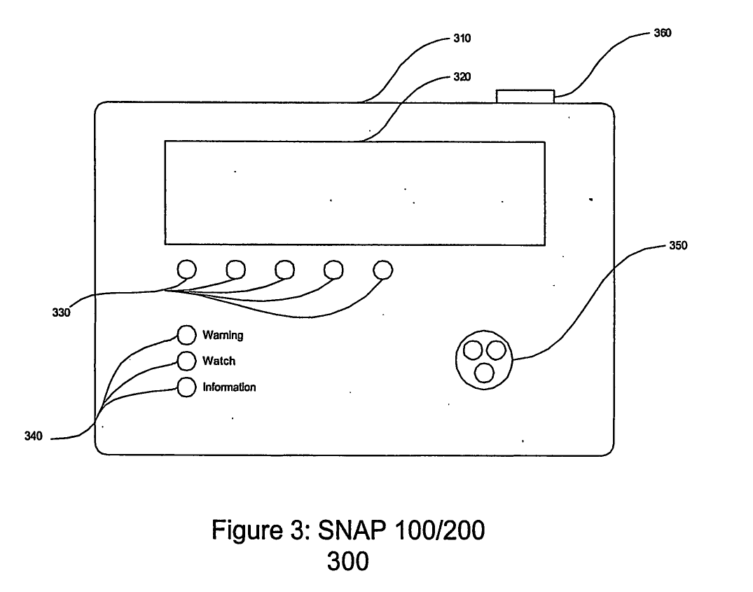

Referring now to FIG. 3, one preferred device 300 is shown that provides for the wireless reception of messages. Device 300 includes a case 310 having a display 320, control buttons 330, urgency indicators 340, speaker 350, and telephone jack 360. A receiver and antenna are located inside case 310. Device 300 is preferably powered by normal household power but includes a battery backup in case of power failure. Device 300 may preferably be a stand-alone device but may also be integrated into an existing desktop computer, with the computer processing the signal and displaying the information.

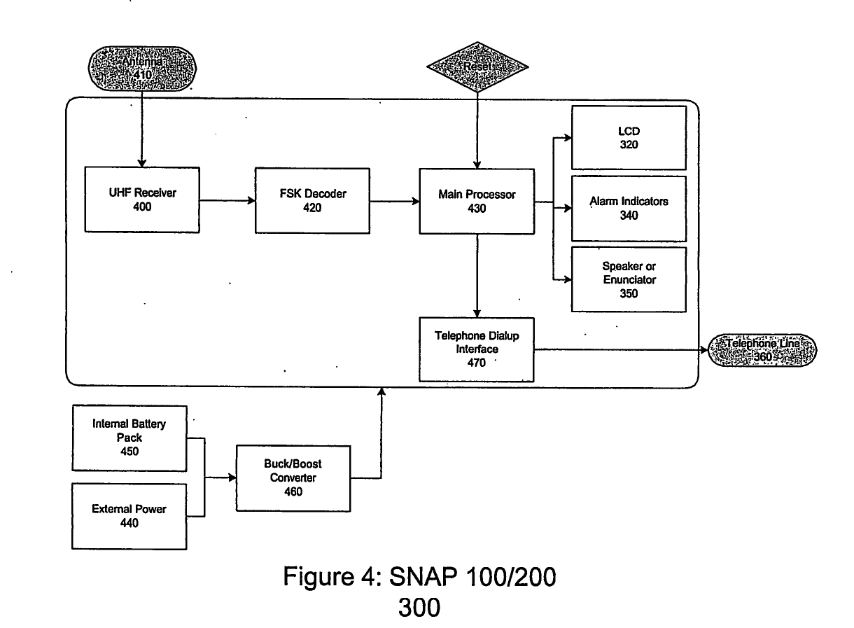

Referring now to FIG. 4, device 300 has a radio frequency receiver 400, in the 450 or 900 Mhz range, that has the capability of receiving FSK data transmissions via antenna 410. The raw data from receiver 400 is then routed into an algorithm decoder 420 that can be set up for either the FLEX or POCSAG protocol. Decoder 420 contains programmable capcodes that identify the uniqueness of the particular device and can be set to respond to all calls, area calls or specific unit calls. This algorithm decoder 420 may be in a separate integrated circuit or may be included in the main microprocessor 430.

The data that the unit receives will be displayed on a display 320. Display 320 may be any type of display, such as a 20 character by 4 line liquid crystal display (LCD) or a 240 by 128 pixel display. The type of message will be displayed by light emitting diode indicators 340. In the preferred embodiments, normal messages are green, watch messages are yellow and warning messages are red. Along with the LED indicators 340, an audio speaker or enunciator 350 with a 90 decibel audio level provides aural alert capabilities. In the preferred embodiments, a 500 millisecond alert is provided with each watch message and a 3 second alert is provided with each warning message and these alerts are repeated every 30 seconds until the reset button is actuated.

The unit also has the capabilities of storing messages in its internal memory for future retrieval. The unit is powered via two methods. The first is from a wall transformer which provides external power 440 to the unit as well as internal batteries 450 providing backup power. The two power sources are sent into a boost/buck converter 460 which converts the incoming power into usable voltage levels.

Telephone jack 360 connects a telephone line to dialup interface 470. When one of control buttons 330 is pressed to acknowledge the receipt of a message, main processor 430 activates dialup interface 470 to send a signal confirming the receipt of the message. This confirmation signal may be sent upon acknowledgement or stored and sent at a later time.

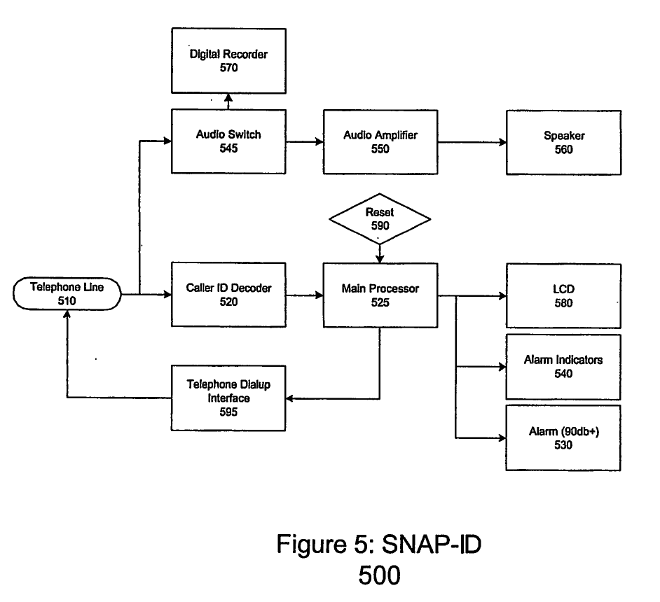

Referring now to FIG. 5, a telephone-based receiving device 500 is shown. Device 500 receives signals via telephone line 510. The signal is received into a caller identification decoder 520 and microcontroller 525 that act like conventional caller ID on all normal numbers. When a call is received from a designated emergency number the system automatically answers the call, activates audio alarm 530 to set off an alert tone, and initiates a visual alarm 540 bliking red LED for visual indication. The message is broadcast by audio switch 545 and audio amplifier 550 into speaker 560 and stored on internal digital audio recorder 570. The message is displayed on LCD display 580.

Device 500 continues the audio and visual alert sequence until reset by pulsing audio alarm 530 and visual alarm 540 until reset button 590 is pressed. Once reset button 590 is pressed, the digital recorder 570 plays back message and audio 530 and visual alarms 540 are reset. Controller 525 the initiates a verification sequence using dialup interface 595 to place a return phone call acknowledging receipt of the message.

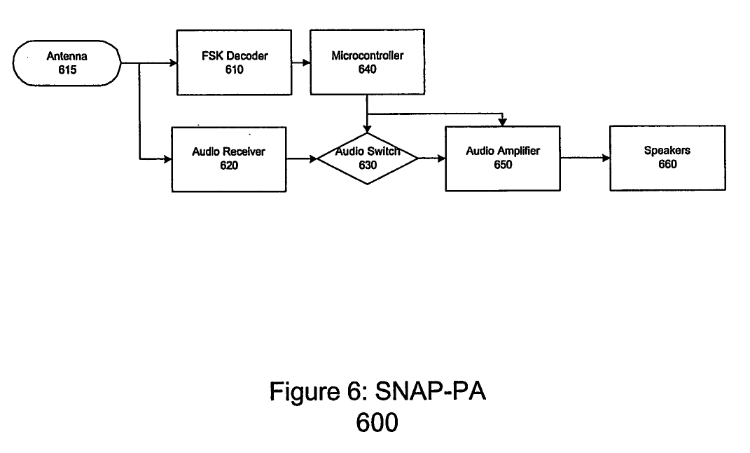

Referring now to FIG. 6, a device 600 is shown for providing emergency alert notification in public places. Device 600 includes of a set of two receivers 610, 620 for reception of the emergency information over antenna 615, an audio switch 630, microcontroller 640, audio amplifier 650, and speaker 660. The first, receiver 610 is a frequency shift keying (FSK) receiver that operates either in the 450 or 900 Mhz band and passes the trigger data information to the main microcontroller 640 for decoding. The decoding algorithm may be either FLEX or POCSAG. The second receiver 620 receives audio signals and transmits those signals to audio switch 630. The microcontroller 640 controls audio switch 630 that allows the passage of audio from the second receiver 620 to the audio amplifier 650 and onto the speaker 660. Receivers 610, 620 operate on two different frequencies for additional security and the decoder requires two levels of decoding to open up the audio channel for rebroadcast. The unit 600 is powered through external power sources but also preferably has battery backup capability.

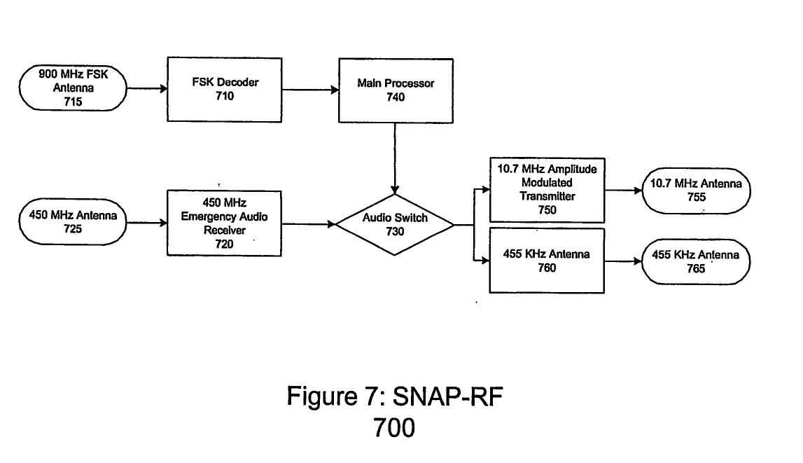

Referring now to FIG. 7, a radio-based device 700 similar to device 600 is shown. Device 700 includes of a set of two receivers 710, 720, with corresponding receiving antenna 715, 725, for reception of the emergency information, an audio switch 730, microcontroller 740, and two transmitters 750, 760, with corresponding transmitting antenna 755, 765. The first receiver 710 is a frequency shift keying (FSK) receiver that operates either in the 450 or 900 Mhz band and passes the trigger data information to the main microcontroller 740 for decoding. The decoding algorithm may be either FLEX or POCSAG. The second receiver 720 receives audio signals and transmits those signals to audio switch 730. The microcontroller 740 controls audio switch 730 that allows the passage of audio from the second receiver 720 to the transmitters 750, 760.

Receivers 710, 720 operate on two different frequencies for additional security and the decoder requires two levels of decoding to open up the audio channel for rebroadcast. The unit 700 is powered through external power sources but also preferably has battery backup capability. Transmitters 750, 760 transmit on the intermediate frequencies of most automobile radios, namely 455 Khz and 10.7 Mhz. By using amplitude modulation on both frequencies, the transmitters 750, 760 will override the front-end of the radio tuned to any AM station and pass the emergency audio through the speaker. If the radio is tuned to a FM station, the signal on 10.7 Mhz will force the detector into slope modulation. This counteracts the automatic frequency control (AFC) circuitry in the radio and allows the emergency audio to be broadcast.

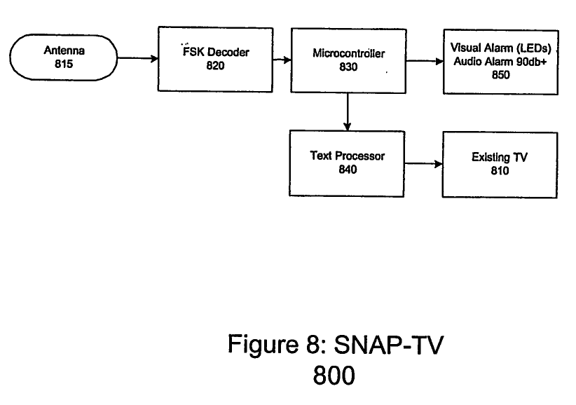

Referring now to FIG. 8, a device 800 is shown integrated into or connected to a conventional television 810. Device 800 includes antenna 815, receiver 820, microcontroller 830, text processor 840, and alarms 850. Data is sent from the main microcontroller 830 to text processor 840, which formats the information to be put on the television screen 810 through video input. The television signal coming to the television is sampled and the vertical and horizontal signals are sampled and synced with the data being provided by the microcontroller 830. The preferable result is text messaging on the lower third of the television screen. The audio and visual LED alarms 850 are on a companion box providing alert of an incoming message.

In a similar embodiment, a television based system may also include a dedicated cable television channel devoted to emergency information. A cable connection provides larger signal bandwidth allowing much greater detail can be received on the channel that can be specific to the area where the customer lives. A sample of the cable signal is sent to a receiver for decoding. The signal is also sent via the airways and received by a receiver. When an emergency message is detected, the unit alerts the customer and the television channel is redirected to the dedicated channel for more detail. A simplified version of the information can also displayed via text display on the television screen if the cable connection has been disrupted.

Alternate embodiments may include Global Positioning System (GPS) technology so as to identify the location of receivers that are portable. Standard GPS receiver circuitry may be. built into a receiver. This circuitry would be capable of generating a stream of information that includes the current latitude and longitude position of the receiver. The National Marine Electronics Association (NMEA) standard 0183 defines and standardizes the format of the information stream. By parsing the data stream the latitude and longitude may be converted to degrees of latitude and longitude and fractions of a degree.

For most locations, a sufficient approximation is that one-degree of latitude and longitude is 111 kilometers so that by capturing the first and second decimal places, a radius of 1.11 kilometers is established as a degree of accuracy. Assuming that the base location is North Latitude and West Longitude, digits identifying the hemisphere may be neglected. Thus, a location at 30 degrees, 22 minutes, and 43.043 seconds North Latitude and 95 degrees, 29 minutes, and 52.872 seconds West Longitude would resolve to a latitude of 30.378623, and a longitude of 095.498020. Selecting the latitude and rounding to the first two decimal places, and the longitude and rounding to the first two decimal places, a string of nine digits may be generated as follows: 303809550.

This string of nine digits may then be used as a capeode to identify a location within a radius of 1.11 kilometers of the precise latitude and longitude. Thus, by programming the receiver to receive only messages that match the current capcode that is generated from the GPS system, the receiver will only display messages that are geographically relevant to that location. This allows an unprecedented degree of accuracy in targeting emergency messages to a mobile receiver.

In certain embodiments, a receiver preferably retains the ability to function even during a loss of household or business electrical power. This can be accomplished through the use of rechargeable batteries in the receiver coupled with AC power delivered through a small wall transformer. Additionally, a rechargeable battery may be integrated into the packaging of the wall transformer. Thus, the power supply would trickle charge the internal battery when external power is available and deliver DC power, from it's own internal Nickel-Metal Hydride battery pack, to the receiver upon a loss of external AC power. The electronics in the power supply can charge and monitor the charge level of both it's own internal batteries and the batteries within the receiver. By packaging the rechargeable battery in the wall transformer, the size and weight of the receiver may also be reduced.

While various preferred embodiments of the invention have been shown and described, modifications thereof can be made by one skilled in the art without departing from the spirit and teachings of the invention. The embodiments herein are exemplary only, and are not limiting. Many variations and modifications of the apparatus and methods disclosed herein are possible and within the scope of the invention. Accordingly, the scope of protection is not limited by the description set out above, but is only limited by the claims which follow, that scope including all equivalents of the subject matter of the claims.

What is claimed is:

1. A method comprising:
acquiring data from one or more sources;
identifying reportable events by comparing the acquired data to selected criteria;
generating messages describing the identified events; and
transmitting the generated messages to one or more receivers.

2. The method of claim 1, further comprising transmitting data as to the time, place, urgency, and nature of the event to the one or more users.

3. The method of claim 1 wherein the messages are transmitted via telephone signals.

4. The method of claim 1 wherein the messages are transmitted via radio signals.

5. The method of claim 1 further comprising the one or more receivers generating an audio and/or visual alarm in response to a message being received.

6. The method of claim 1 further comprising receiving an acknowledgement of receipt of the messages from the one or more receivers.

7. The method of claim 1 wherein the one or more sources comprises at least one of a radio source, satellite source, internet source, provider source, weather source, or television source.

8. A method for managing information comprising:
gathering data from a plurality of input sources;
detecting an event by comparing the data to a user-specific event watch list;
recording data associated with a detected event;
analyzing the recorded data to determine an urgency and affected area for a detected event;
generating a message based on the urgency and affected area for a detected event; and
distributing the message to one or more selected receivers within the affected area.

9. The method of claim 8 further comprising the one or more selected receivers generating an audio and/or visual alarm in response to the message being received.

10. The method of claim 8 further comprising transmitting an acknowledgement of receipt from the one or more selected receivers in response to the message being received.

11. The method of claim 8 wherein the plurality of input sources comprise at least one of a radio source, satellite source, internet source, provider source, weather source, or television source.

12. The method of claim 8 wherein the urgency of a message is dependent on the location of a receiver within the affected area.

13. A device comprising:
a receiver operable to receive messages and data that are transmitted from an information processing system, wherein the messages and data are generated in response to information received by the information processing system and compared to a watch list;
a display operable to display information from the received messages and data; and
a speaker operable to broadcast audible signals in response to the received messages and data.

14. The device of claim 13 further comprising one or more indicators activated in response to the received messages and data.

15. The device of claim 13 further comprising a transmitter operable to send an acknowledgement to the information processing system once the message and data have been received.

16. The device of claim 13 wherein said receiver is a telephone receiver.

17. The device of claim 13 wherein said receiver is a radio receiver.

18. The device of claim 13 wherein the message and data received are dependent on the location of the device.
